(19) United States
(12) Patent Application Publication
(10) Pub. No.: US 2006/0268050 A1
(43) Pub. Date: Nov. 30, 2006

(54) NOZZLE FACE-CLEANING METHOD

(75) Inventor: Yoichi SONOBE, Ibaraki (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 11/383,215

(22) Filed: May 14, 2006

(30) Foreign Application Priority Data
May 30, 2005 (JP) 2005-156816

(51) Int. Cl. B41J 2/165

(52) U.S. Cl. 347/29

(57) ABSTRACT

The nozzle faces 22Ks, 22Cs are cleaned with a wiper blade 150 under application of a weak negative pressure to the ink in the nozzles 22Kn, 22Cn. A pressure equal to the atmospheric pressure (the pressure outside the nozzles 22Kn, 22Cn) is applied to the inks in the nozzles 22Kn, 22Cn, and thereby the meniscus Mc and Mk are formed at the ejection outlets 22Ci, 22Ki on the same plane as the nozzle faces 22Cs, 22Ks.

### TECHNICAL FIELD

The present invention relates to a method for cleaning a nozzle plate face (herein after simply referred to as a nozzle face) by wiping off an ink depositing on the nozzle face with a wiper blade.

### BACKGROUND ART

Inkjet type image-forming apparatuses (inkjet printers) are widely used which form an image by ejecting ink as droplets through ink ejection outlets of plural nozzles of a printing head. In a known technique for ejecting ink droplets through a nozzle, a thermal energy is applied to an ink in the nozzle to cause film-boiling of the ink to eject an ink droplet from the nozzle by the pressure of the bubble formed by the film boiling. By this technique, ink droplets are ejected through plural nozzles toward a recording medium to form an image on the recording medium.

To improve an image-recording speed (image-forming speed), some of the inkjet printers employing the above technique have a multiple-nozzle line head, each nozzle having ink ejection outlets and ink flow channels, arranged in the direction perpendicular to the recording medium delivery direction, and eject the ink from plural nozzles simultaneously in correspondence with the delivery of the recording medium (line printer).

The image-forming apparatuses are required to form an image at a higher speed with a higher image quality and higher resolution. The inkjet printers including the above-mentioned line printers satisfy the requirement. Further, since the printing head (recording head) of the inkjet printer is not brought into contact with the recording medium, the inkjet printer can record an image with high stability.

In recording with the aforementioned inkjet type image-forming apparatus, thickened ink or dirt can accumulate in the nozzle and around the ink-ejection outlets of the nozzles of the printing head to cause inconvenience such as failure of ink ejection or irregularity of recording. To overcome such inconvenience, a recovery technique is known for cleaning the head by sucking the ink from the nozzle and removing the cap several times (Japanese Patent Application Laid-Open No. H-05-000517). However, in this recovery operation, a large amount of the ink is sucked out together with the bubble, which may cause deposition of the ink on the nozzle face. This can cause deviation of the ink ejection direction to lower the image quality. Moreover, paper dust coming from the recording medium or dirt in the image-forming apparatus is liable to deposit on the nozzle face to cause deviation of the ink ejection direction or failure of ink ejection to lower the image quality.

To overcome such inconvenience, a technique is disclosed in which, after sucking the ink from the nozzle, the nozzle face is wiped with a wiper blade (Japanese Patent Application Laid-Open No. H-10-250087). In an inkjet type image-forming apparatus, for example, having four printing heads for ejecting four color inks, one wiper blade is employed for one printing head, and the nozzle faces of the four printing heads are wiped respectively with a separate wiper blade.

When the respective printing heads are wiped with separate wiper blades, one blade for one color nozzle face, a wiper blade used for wiping a yellow ink-ejecting nozzle face, for example, is not brought into contact with a black ink-ejecting nozzle face. However, for apparatus size reduction, some apparatuses employ one wiper blade for wiping plural color printing heads.

In the apparatus in which one wiper blade is used for wiping different color nozzle faces successively, plural color inks will attach mixedly onto the wiping face (wiping edge) of the wiper blade to form a mixed color ink. When the wiper blade retaining the mixed color ink is used again for wiping the nozzle face, the mixed color ink comes to attach to the wiped nozzle face, and the mixed color ink can diffuse or penetrate through the ejection outlet into the nozzle. The mixed color ink having penetrated into the nozzle, when ejected from the nozzle of image formation together with the normal color ink, can change the recorded image color from the designed color to lower remarkably the formed image quality.

To prevent the fall of the image quality by the mixed color ink, after the wiping operation (after the wiping of the nozzle face with the wiper blade), preliminary ejection of prescribed times is conducted to discharge the mixed ink having penetrated into the nozzle of the printing head before printing. However, when the preliminary ejection is conducted a long time after the wiping operation, the ink can penetrate in a larger amount into the nozzle to necessitate more repetition times of preliminary ejection, resulting in increase of the amount of the discarded ink.

### DISCLOSURE OF THE INVENTION

The present invention intends to provide a method for cleaning a nozzle face to prevent troubles caused by undesirable ink mixing and decrease the amount of discarded ink under the aforementioned circumstance.

A method of the present invention for cleaning a nozzle face, of an inkjet type image-forming apparatus for forming an image by ejecting an ink onto a recording medium through an ink ejection outlet of a nozzle having a meniscus of the ink, by wiping off the ink attaching to the nozzle face with a wiper blade,
(1) wherein, in wiping of the ink off from the nozzle face, the ink in the nozzle is pressurelized (a pressure is applied to the ink in the nozzle) to prevent penetration of the ink from the wiper blade through the ink ejection outlet into the nozzle.

Another method of the present invention for cleaning a nozzle face, of an inkjet type image-forming apparatus for forming an image by ejecting an ink onto a recording medium through an ink ejection outlet of a nozzle having a meniscus of the ink by wiping off the ink attaching to the nozzle face with a wiper blade,
(2) wherein, in wiping of the ink off from the nozzle face, a meniscus of the ink is formed flat on the same face as the nozzle face or to be convex to protrude from the nozzle face at the ink ejection outlet.

Still another method of the present invention for cleaning a nozzle face, of an inkjet type image-forming apparatus for forming an image by ejecting an ink through an ink ejection outlet of a nozzle having a meniscus of the ink onto a recording medium, by wiping off the ink attaching to the nozzle face with a wiper blade,
(3) wherein, in wiping of the ink off from the nozzle face, a pressure higher than the atmospheric pressure is applied to the ink in the nozzle.

In the above method,
(4) the inkjet type image-forming apparatus has plural printing heads arranged in the direction of the recording medium delivery and ejecting different inks,
(5) the plural printing heads respectively have a nozzle face having plural ink ejection outlets arranged in the direction perpendicular to the recording medium delivery direction, and
(6) the nozzle faces of the printing heads are cleaned successively by moving the wiper blade in the direction of the recording medium delivery or in the direction reverse thereto.

In the inkjet type image-forming apparatus of the present invention for achieving the above object,
(7) the nozzle face is cleaned by the above nozzle face cleaning method, and image is formed by ejection of an ink onto a recording medium.

According to the present invention, in wiping an ink attaching to the nozzle face by a wiper blade, a pressure for preventing penetration of the ink from the wiper blade through the ink ejection outlet is applied to the ink in the nozzle. Therefore, the ink wiped by the wiper blade does not penetrate into the nozzle, which prevents trouble caused by the mixed color ink. Further, the amount of the ink discarded from the nozzle is decreased, since the ink does not penetrate through the ink ejection outlet into the nozzle.

### BRIEF DESCRIPTION OF THE DRAWINGS

FIG. 1 is a schematic front view of an example of a printer employing the ink nozzle face-cleaning method of the present invention.

FIG. 2 is a block diagram showing an electric system of the printer shown in FIG. 1.

FIG. 3 illustrates schematically an ink-feeding device incorporated in an inkjet type image-forming apparatus.

FIG. 4 is an enlarged view illustrating a sub-tank and a printing head in detail.

FIG. 5 is a plan view of vanes of a pressure-controlling pump.

FIG. 6 is a graph showing the dependency of the pressure applied to the ink in the printing head on the rotation frequency of the vane shown in FIG. 5.

FIG. 7A is a front view illustrating schematically the printing heads and a recovery unit at a circulation position. FIG. 7B is a front view illustrating schematically the printing heads and the recovery unit at the blading position. FIG. 7C is a front view illustrating schematically the printing heads and the recovery unit at the capping position. FIG. 7D is a front view illustrating schematically the printing heads and the recovery unit at the printing position.

FIG. 8A is a sectional view illustrating schematically a state of two nozzle faces just before cleaning with a wiping blade. FIG. 8B is a sectional view illustrating schematically a state of cleaning of a first nozzle face with the blade. FIG. 8C is a sectional view illustrating schematically a state of cleaning of a second nozzle face with the blade after cleaning of the first nozzle face. FIG. 8D is a sectional view illustrating schematically a state at the end of the cleaning of the second nozzle face.

FIG. 9 is a graph showing the dependency of the amount of the ink sucked from the ink outlet per unit time and the amount of the ink discarded for removing the mixed color ink layer portion on the negative pressure applied to the ink in the nozzle.

FIG. 10A is a sectional view illustrating schematically a state of two nozzle faces just before cleaning with a blade. FIG. 10B is a sectional view illustrating schematically a state of cleaning of a first nozzle face with the blade. FIG. 10C is a sectional view illustrating schematically a state of cleaning of a second nozzle face with the blade after cleaning of the first nozzle face. FIG. 10D is a sectional view illustrating schematically a state at the end of the cleaning of the second nozzle face.

FIG. 11 is a flow chart of steps of controlling the pressure in the printing head for recovery operation by pressured circulation.

### BEST MODE OF CARRYING OUT THE INVENTION

The present invention has been realized in an inkjet type printer for forming an image by ejecting inks through ink ejection outlets provided in a printing head.

### EXAMPLE 1

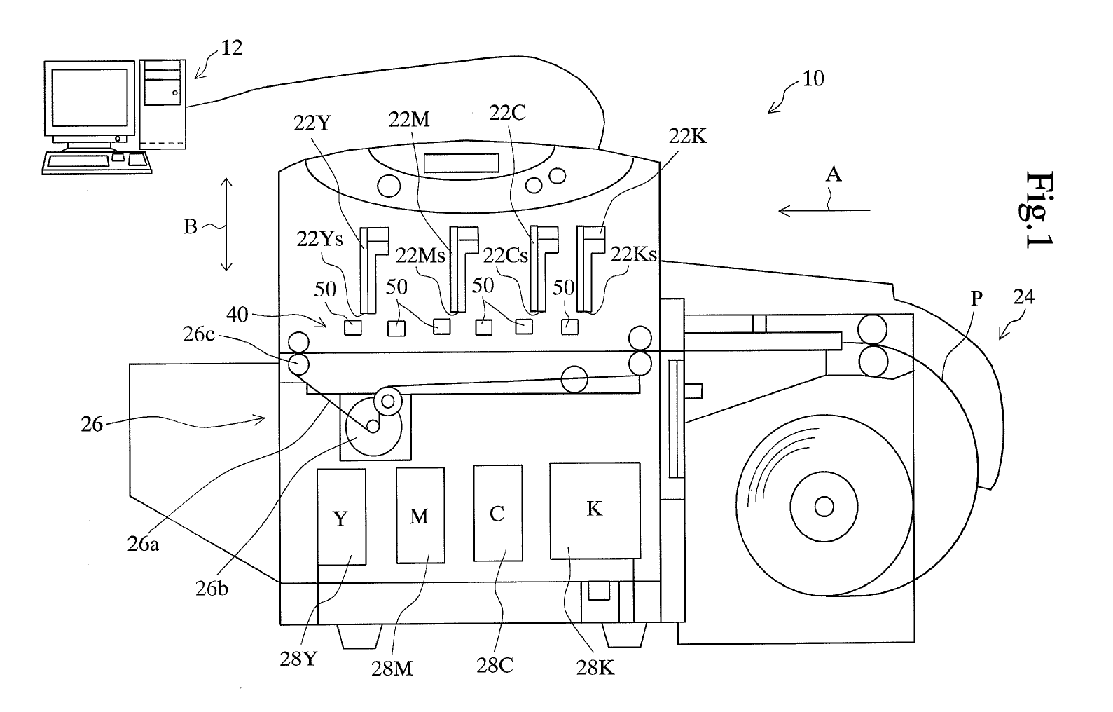

An example of the printer employing the nozzle face-cleaning method of the present invention is explained by reference to FIG. 1.

FIG. 1 is a schematic front view of an example of a printer employing the nozzle face-cleaning method of the present invention.

A printer 10 is connected to a host PC (personal computer) 12. The PC transmits image information to the printer 10. The printer 10 has four printing heads 22K, 22C, 22M, 22Y arranged in the delivery direction (arrow-A direction) of a recording medium P (rolled paper sheet in this Example). The four printing heads 22K, 22C, 22M, 22Y eject respectively a black ink, a cyan ink, a magenta ink, and a yellow ink. Each of the printing heads 22K, 22C, 22M, 22Y is a so-called line-head and extends in the direction perpendicular to the face of the drawing of FIG. 1 (perpendicular to the arrow-A direction). The lengths of the four printing heads 22K, 22C, 22M, 22Y are a little larger than the maximum breadth of the recording medium for printing by the printer 10. The four printing heads 22K, 22C, 22M, 22Y are fixed (not movable) during image formation. An example of the aforementioned printer is a name card printer for preparing many name cards at a high speed.

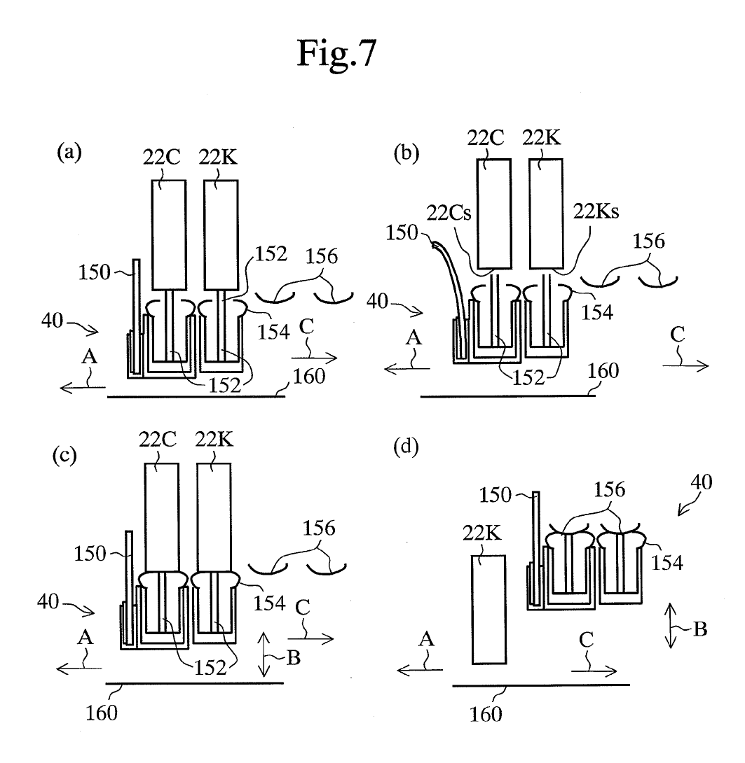

The printer 10 incorporates a recovery unit 40 for stable ink ejection through the four printing heads 22K, 22C, 22M, 22Y. By use of the recovery unit 40, the initial ejection state of the four printing heads 22K, 22C, 22M, 22Y can be recovered. The recovery unit 40 has capping mechanisms 50 which remove the ink, for ejection recovery, from the front faces 22Ks, 22Cs, 22Ms, 22Ys of ejection nozzles 22K, 22C, 22M, 22Y. The capping mechanisms 50 are independent of the printing heads 22K, 22C, 22M, 22Y. FIG. 1 shows six capping mechanisms 50 for six colors, two of which are spares for additional printing heads. The capping mechanism 50 includes a wiper blade 150 (FIG. 7, etc.; hereinafter referred simply as a blade), an ink-removing member, a blade-holding member, and a cap.

A rolled paper sheet P is fed from a rolled paper-feeding unit 24, and is delivered in the arrow-A direction by a delivery mechanism 26 incorporated in the printer 10. The delivery mechanism 26 incorporates a delivery belt 26afor delivering the rolled paper sheet P, a delivery motor 26b for driving the delivery belt 26a, and a tension roller 26c for applying tension to the delivery belt 26a.

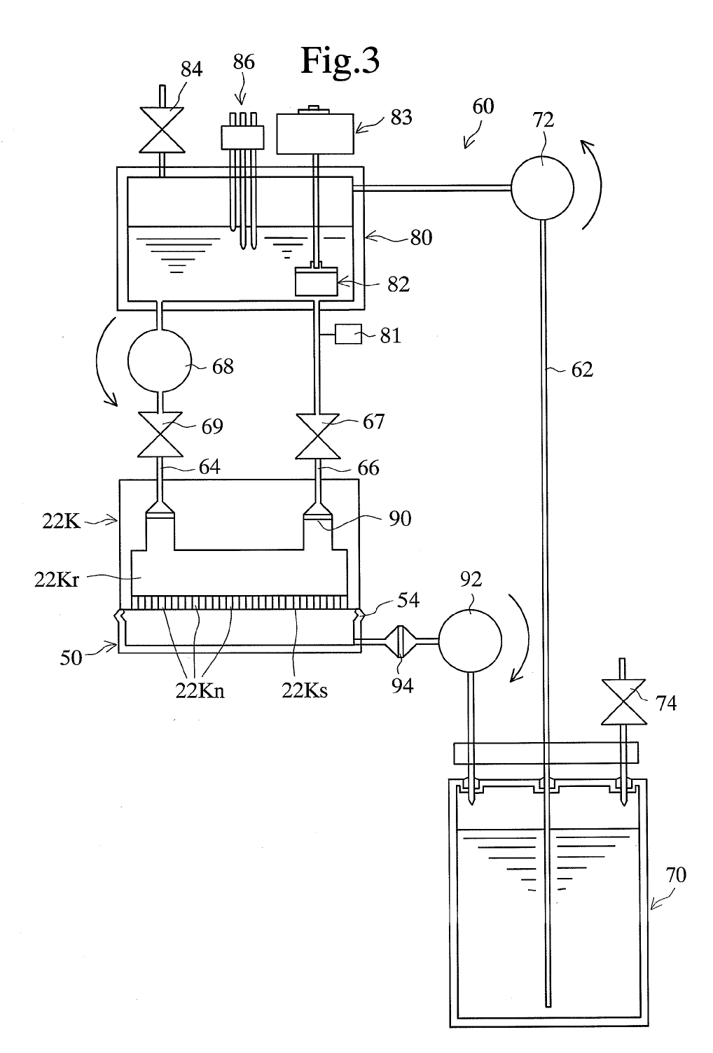

For forming an image on the rolled paper sheet P, the record-starting position of the rolled paper sheet P is brought under the black printing head 22K, and a black ink is selectively ejected through the printing head 22K in accordance with the recording data (image information). Thereafter, similarly the color inks are ejected through the printing head 22C, printing head 22M, and printing head 22Y in the named order to form a color image on the rolled paper sheet P. The printer 10 includes, in addition to the aforementioned parts and members, main tanks 28K, 28C, 28M, 28Y for storing inks to be supplied to the printing heads 22K, 22C, 22M, 22Y, and pumps (FIG. 3, etc.) for supplying the inks to the printing heads 22K, 22C, 22M, 22Y, and for the recovery operation.

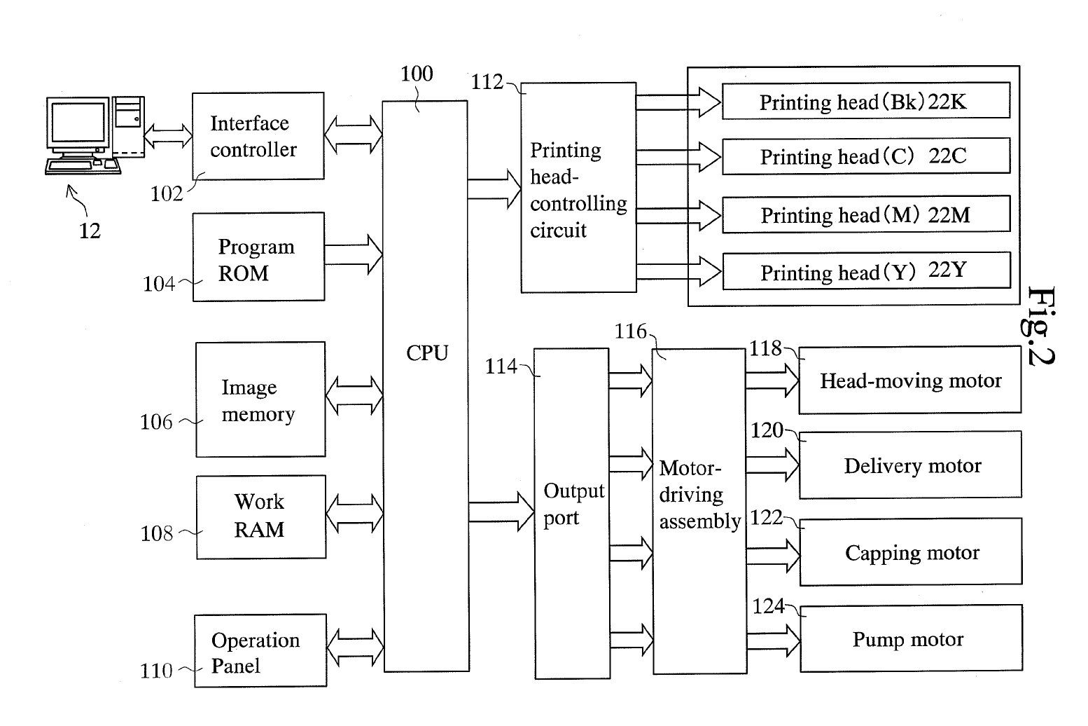

The electric system of the printer 10 is explained by reference to FIG. 2.

FIG. 2 is a block diagram showing the electric system of the printer shown in FIG. 1.

The data or commands for recording are transmitted from the host PC 12 through an interface controller 102 to a CPU 100. The CPU 100 is a central processing unit for controlling the printer 10 as a whole such as reception of recording data, operation of recording, and handling of the rolled paper sheet P. The CPU 100, after analyzing received commands, develops the image data of the respective color as a bit map in the image memory 106 and draws an image. As the operation prior to the recording, a capping motor 122 and a head-moving motor 118 are driven through an output port 114 and a motor-driving assembly 116 to move the recording head 22K, 22C, 22M, 22Y apart from the capping mechanisms 50 to the recording position (image formation position).

Then a roll motor (not shown in the drawing) for sending out the rolled paper sheet P and a delivery motor 120 for delivering the rolled paper sheet P at a low delivery rate are driven through the output port 114 and the motor-driving assembly 116 to deliver the rolled paper sheet P to the recording position. The position of the leading edge of the rolled paper sheet is detected by a leading edge-detecting sensor (not shown in the drawing) to decide the timing of ejection of the ink onto the rolled paper sheet P being delivered at a constant rate. Thereafter, in synchronization with the delivery of the rolled paper sheet P, the CPU 100 reads out corresponding color recording data from the image memory 106 successively, and transmits the read-out data through a printing head-controlling circuit 112 to the respective printing heads 22K, 22C, 22M, 22Y.

The CPU 100 is operated in accordance with the processing program memorized in a program ROM 104. The program ROM 104 memorizes processing program and tables corresponding to the control flow. A work RAM 108 is used as the operation memory. In the operations of cleaning and recovery of the respective printing heads 22K, 22C, 22M, 22Y, the CPU 100 controls ink pressurization and ink sucking by driving a pump motor 124 through an output port 114 and a motor-driving assembly 116.

FIG. 3 is a schematic drawing of an ink-feeding device incorporated in an inkjet type image-forming apparatus. FIG. 3 shows an ink-feeding device for feeding an ink to printing head 22K and recovering the printing head 22K. Other printing heads 22C, 22M, 22Y are also equipped with ink-feeding devices of the same constitution. In FIG. 3, the same symbols as in FIG. 1 and FIG. 2 are used to indicate corresponding elements.

The printer 10 (FIG. 1) incorporates an ink-feeding device 60 for feeding an ink to a printing head 22K. The ink-feeding device 60 has an ink tank 70 demountable from the main body of the printer 10, and a sub-tank 80 placed within an ink feed channel 62 connecting the ink tank 70 to the printing head 22K. The printing head 22K is placed at a position lower than the sub-tank 80.

The sub-tank 80 and the printing head 22K are connected by two ink flow channels 64,66. The sub-tank 80 and the members therefrom to the pressure valve 67 and the members to the standby valve 69 are fixed to the main body frame of the printer 10. Portions of the ink flow channels 64,66 are made of a flexible tube to enable movement of the printing head 22K. In the ink flow channel 64, are installed a cleaning pump 68 which is driven at the time of cleaning the printing head 22K, a standby valve 69 which opens and closes the ink flow channel 64 at a prescribed timing. On the other hand, within the ink flow channel 66, a pressure valve 67 is installed which opens and closes the ink flow channel 66 at a prescribed timing. Further in the ink flow channel 66, between the pressure valve 67 and the pressure-adjusting pump 82 mentioned below, a pressure sensor 81 is installed to detect the ink pressure in the ink flow channel 66. The pressure detected by the pressure sensor 81 corresponds to the pressure applied to the ink in the nozzle 22Kn.

Inside the sub-tank 80, a pressure-adjusting pump 82 is installed for applying an appropriate pressure to many nozzles 22Kn of the printing head 22K. This pressure-adjusting pump 82 is placed a little above the bottom face of the sub-tank 80, apart at a prescribed distance from the bottom face. The pressure-adjusting pump 82 is submerged in the ink in the sub-tank 80. A driving unit 83 for driving the pressure-adjusting pump 82 is placed above the sub-tank 80. This driving unit is controlled by the CPU 100 (FIG. 2). On the ceiling wall of the sub-tank 80, an air-communication valve 84 is placed to keep the inside pressure of the sub-tank 80 at an atmospheric pressure. The inside pressure of the sub-tank 80 is made equal to the atmospheric pressure by opening this air-communication valve 84.

A conventional usual liquid-level sensor 86 is installed in the sub-tank 80 for detecting the liquid face level of the ink (stored ink) in the sub-tank 80. When the liquid-level sensor 86 detects the ink face level in the sub-tank 80 to be lower than a prescribed level, a feed pump 72 is started to suck the ink from the ink tank 70 to feed the ink to the sub-tank 80. On the other hand, when the liquid-level sensor 86 detects the ink face level in the sub-tank 80 to reach a prescribed upper-limit level, the feed pump 72 is stopped to interrupt the ink feed.

In the ink tank 70, a sensor is installed (not shown in the drawing) for detecting the presence of the ink in this ink tank 70. In the air flow path for mounting the ink tank 70 on the main body of the printer 10, an air-communication valve 74 is installed for equalizing the inside pressure of the ink tank 70 to the atmospheric pressure.

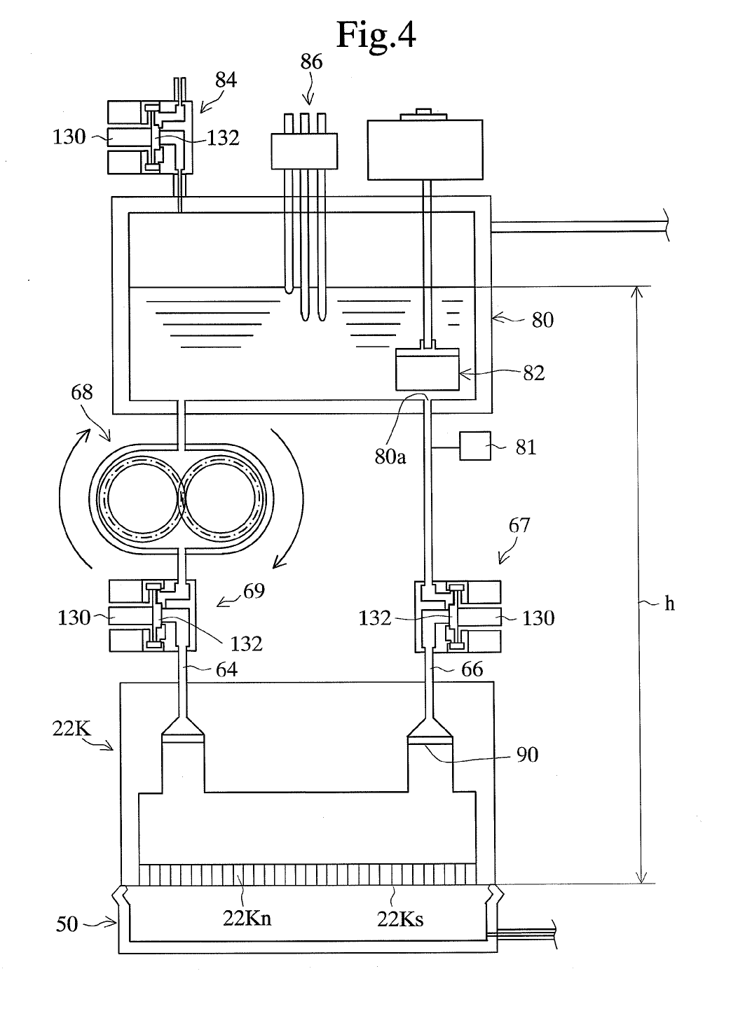

A technique for adjusting the pressure in the printing head 22K by a pressure-adjusting pump 82 is explained below by reference to FIGS. 4-6.

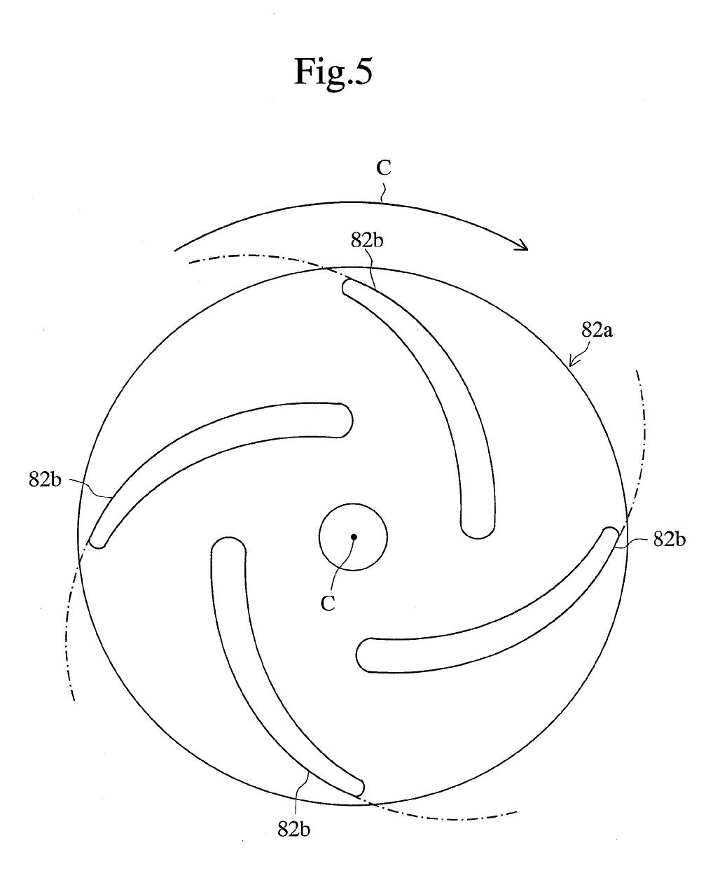

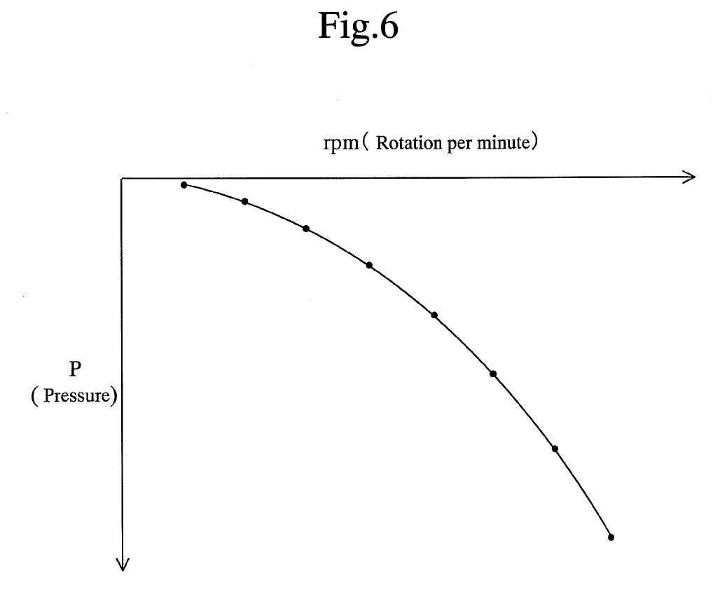

FIG. 4 is an enlarged drawing illustrating a sub-tank and a printing head in detail. FIG. 5 is a plan view showing vanes of a pressure-adjusting pump. FIG. 6 is a graph showing dependency of the pressure applied to an ink in a printing head on the rotation frequency of the vanes shown in FIG. 5. In these drawings, the same reference numbers and symbols as in FIG. 3 are used for indicating corresponding elements.

The aforementioned pressure valve 67, the standby valve 69, and the air-communication valve 84 are, as shown in FIG. 4, respectively an electromagnetic valve which intercepts the ink flow channel by a valve sheet 132 integrated with a solenoid plunger 130. However, any type of the valve may be used in the present invention without limiting thereto.

In the recording, a suitable negative pressure should be applied to the printing head 22K. (That is, a pressure is applied to the ink in the nozzle 22Kn to form a meniscus of the ink at the ink ejection opening (outlet of the nozzle 22Kn) of the printing head 22K). For the negative pressure application, the pressure valve 67 and the air-communication valve 84 are opened, and the standby valve 69 is closed. In this state, the pressure-adjusting pump 82 is driven to rotate its blade 82a to apply a centrifugal force from the center C of the blade 82a along the vane faces 82b. Thereby, the portion of the rotation axis (at and around the center C) of the pressure-adjusting pump 82 is subjected to a relatively negative pressure, and the negative pressure can be applied through suction opening 80a of the sub-tank 80 and the ink flow channel 66 to the printing head 22K. The suction opening 80a is formed on the bottom wall of the sub-tank 80, and the pressure-adjusting pump 82 is placed at a certain distance above the suction opening 80a. The rotation frequency of the blade 82a is controlled by the CPU 100 (FIG. 2) As described above, the pressure-adjusting pump 82 is driven to rotate the blade 82a in the arrow-C direction to generate a centrifugal force. Thereby the pressure-adjusting pump 82 pulls the ink in the printing head 22K through the ink flow channel 66 and the suction opening 80atoward the sub-tank 80 (actually, only little amount of the ink is transferred by the suction) to apply a negative pressure (a pressure lower than the atmospheric pressure outside the ink ejection opening) to the ink in the printing head 22K to form a meniscus of the ink at the ink ejection opening. Otherwise, by driving reversely the pressure-adjusting pump 82 to rotate in the direction reverse to the arrow-C direction, the ink in the sub-tank 82 can be pushed outside the suction opening 80a to apply a positive pressure (a pressure higher than the atmospheric pressure outside the ink ejection opening) to the ink in the printing head 22K, and the ink can be pushed outside the ink discharge outlet.

The strength of the negative pressure generated by the pressure-adjusting pump 82 varies as shown in FIG. 6 depending on the rotation frequency of the blade 82a of the pressure-adjusting pump 82 rotating in the arrow-C direction as shown in FIG. 5. The higher the rotation frequency of the blade 82a in the arrow-C direction (larger the rotation number per unit time), the higher is the generated negative pressure. This higher negative pressure tends to suck the ink from the printing head 22K to the sub-tank 82 to apply a higher negative pressure to the ink in the printing head 22K (in the nozzle 22Kn). Conversely, the lower the rotation frequency of the blade 82a in the arrow-C direction (smaller the rotation number per unit time), the lower is the generated negative pressure. This lower negative pressure tends to suck the ink at a lower sucking force from the printing head 22K to the sub-tank 82 to apply a lower negative pressure to the ink in the printing head 22K. Thus, the strength of the negative pressure applied to the printing head 22K can be controlled by the rotation frequency of the pressure-adjusting pump 82, so that the pressure in the printing head 22K (the pressure applied to the ink in the nozzle 22Kn) can be adjusted by driving the pressure-adjusting pump 82 with the ink flow channel 66 kept opened.

The pressure-adjusting pump 82 is preferably a usual turbo type of pump. The turbo type pump includes centrifugal type pumps employed in this Example, diagonal flow type pumps, and axial flow type pumps. Such a pump can generate a pressure without closing the ink flow channel (liquid flow channel). Therefore the ink can pass through the pump depending on the pressure difference. For example, ejection of the ink from the printing head 22K decreases the amount of the ink in the printing head 22K, thus decreasing the pressure between the printing head 22K and the pressure-adjusting pump (centrifugal pump) 82. Owing to this pressure decrease, the ink in the sub-tank 80 is supplied through the ink flow channel 66 to the printing head 22K. In contrast, a volume type pump such as a piston pump, as the pressure-adjusting pump 82, shuts the ink flow channel 66 for sending the ink by pressure, which prevents free movement of the ink through the piston pump and tends to suck the outside air through the ink ejection outlet of the printing head 22K.

The recovery operation by pressured circulation by use of the above recovery unit 40 (FIG. 1) and the capping mechanisms 50 (FIG. 1) is explained briefly below by reference to FIG. 7. The “recovery operation” is conducted for maintaining steadily the quality of the ink ejection through the printing heads 22K-22Y (FIG. 1) after a prescribed total ejection time or on occurrence of irregular ink ejection state or of a lower image quality, automatically or manually.

FIG. 7A is a front view illustrating schematically the printing heads and recovery units at the circulation position. FIG. 7B is a front view illustrating schematically the printing heads and a recovery unit at the blading position. FIG. 7C is a front view illustrating schematically the printing heads and recovery units at the capping position. FIG. 7D is a front view illustrating schematically the printing heads and recovery units at the printing position. In these drawings, the same symbols as in FIG. 1 are used for denoting corresponding constitutional elements.

In the recovery operation, the air-communication valve 84 and the standby valve 67 are opened successively. Then pressure-adjusting pump 82 is driven to pressurize the ink in the ink flow channel 66 to deliver the ink from the sub-tank 80 through the ink flow channel 66 and the filter 90 to the printing head 22K or other printing head (i.e., nozzle 22Kn, etc.). The pressure delivery of the ink forces out the foams accumulated in the liquid chamber 22Kr etc. of the printing head 22K, etc.) during the recording operation, and a foreign matter like a foam or dirt at the periphery of the nozzle 22Kn, etc. of the printing head 22K, etc. together with the ink. In this state, as shown in FIG. 7A, ink guides 152 are brought close to the nozzle faces 22Ks, etc. to guide the discharged ink and the foreign matter to the bottom of the cap 154. In this state, the nozzle faces 22Ks. etc. having the openings (ink outlets) of the nozzles 22Kn of the printing heads 22K, etc. are soiled by ink deposition. To remove the soiling matter, the nozzle face 22Cs and the nozzle face 22Ks are wiped successively with a blade 150 fixed to the capping mechanism 50 as shown in FIG. 7B.

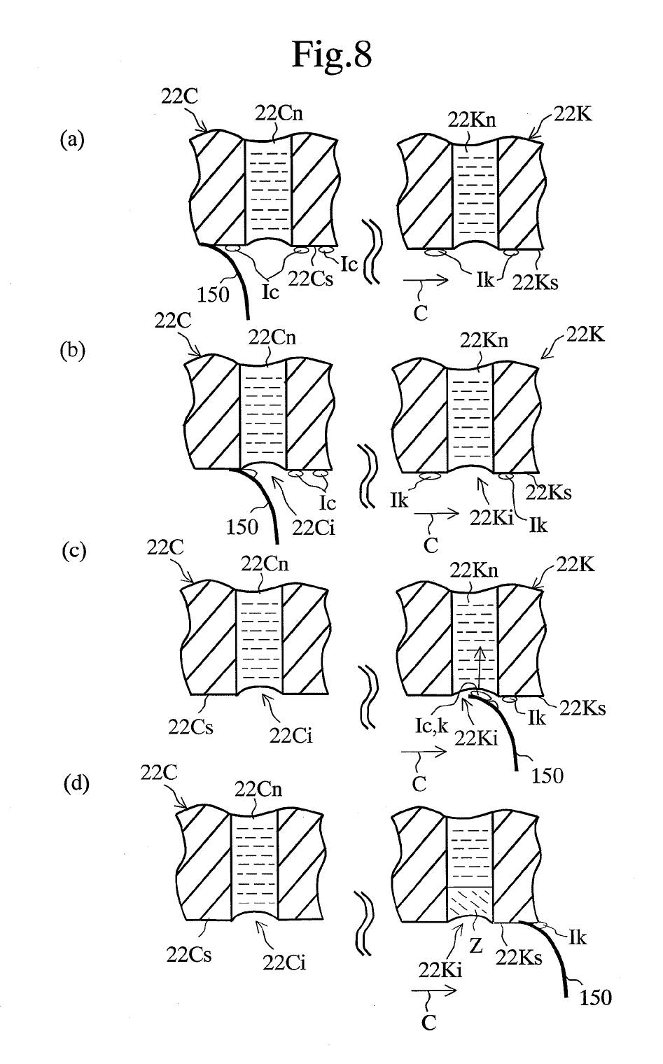

In this wiping operation, firstly as shown in FIG. 7B, the printing heads 22K, etc. are moved up above the recovery caps 154. Subsequently, the caps 154 are moved in the arrow-C direction (reverse to the arrow-A direction) to wipe off a soiling matter such as ink depositing on the nozzle face 22Ks, etc. by the blade 150 as shown in FIG. 8 later. This operation is called a wiping operation.

After the wiping operation, the printing heads 22K, etc. are brought to the capping position and capped with the caps 154 (standby state) as shown in FIG. 7C. In this standby state, the nozzle faces 22Ks, etc. of the printing heads 22K, etc. are capped by the caps 154, whereby the ink in the nozzles 22Kn are prevented from viscosity increase. The ink discharged from the printing heads 22K, etc. (waste ink) received by the caps 154 and is sucked by a suction pump 92 (FIG. 3). The waste ink is filtered through a filter 94 (FIG. 3) to remove (screen) the foreign matter and is returned to the ink tank 70. The wiping operation only may be conducted at a suitable timing. In printing (image formation), as shown in FIG. 7D, the caps 154, etc. are lifted in synchronization with the movement of the printing heads 22K, etc. as shown in FIG. 7D; closing members 156 is moved to close the openings of the caps 154; and the printing heads 22K, etc. are brought close to the recording medium delivery face 160.

The operation of wiping the ink depositing on the nozzle faces 22Ks, 22Cs, etc. successively is explained by reference to FIGS. 8A-8D.

FIG. 8A is a sectional view illustrating schematically a state of two nozzle faces just before cleaning with a wiper blade. FIG. 8B is a sectional view illustrating schematically a state of cleaning of a first nozzle face with the blade. FIG. 8C is a sectional view illustrating schematically a state of cleaning of a second nozzle face with the blade after cleaning of the first nozzle face. FIG. 8D is a sectional view illustrating schematically a state at the end of the cleaning of the second nozzle face.

In FIGS. 8A-8D, with the negative pressure kept applied to the inks in the nozzles 22Kn, 22Cn, the nozzle faces 22Ks, 22Cs are cleaned. The inks Ic, Ik depositing on the nozzle faces 22Cs, 22Ks are wiped off successively with the wiper blade 150. Here, one blade 150 is used for wiping of the ink Ic from the nozzle face 22Cs and successively wiping off the ink Ik from the nozzle face 22Ks.

The blade 150 firstly starts to wipe the ink Ic off from the nozzle face 22Cs of the printing head 22C as shown in FIG. 8A, and then the blade 150 wipes the ink Ic off from the periphery of the ink ejection outlet 22Ci of the nozzle 22Cn as shown in FIG. 8B. Next, the blade 150, with the wiped ink Ic kept attached to the wiping edge portion thereof, wipes the ink Ik off from the nozzle face 22Ks of the printing head 22K. In this wiping step, the blade 150 with the ink Ic attaching thereto crosses the nozzle 22Kn. Since a negative pressure is kept applied to the ink in the nozzle 22Kn, the ink is liable to be sucked from the blade through the ink ejection outlet 22Ki to form a mixed color ink layer portion Z containing the two color inks Ic and Ik near the ink ejection outlet 22Ki of the nozzle 22Kn in a relatively large thickness as shown in FIG. 8D. When such a mixed color ink layer portion Z is formed in a relatively large thickness, the ink in an amount corresponding to the mixed color layer portion Z is ejected from the nozzle 22Kn in the capped state shown in FIG. 7C, and is discarded. The larger thickness of the mixed color layer portion Z necessitates a larger amount of discard of the ink.

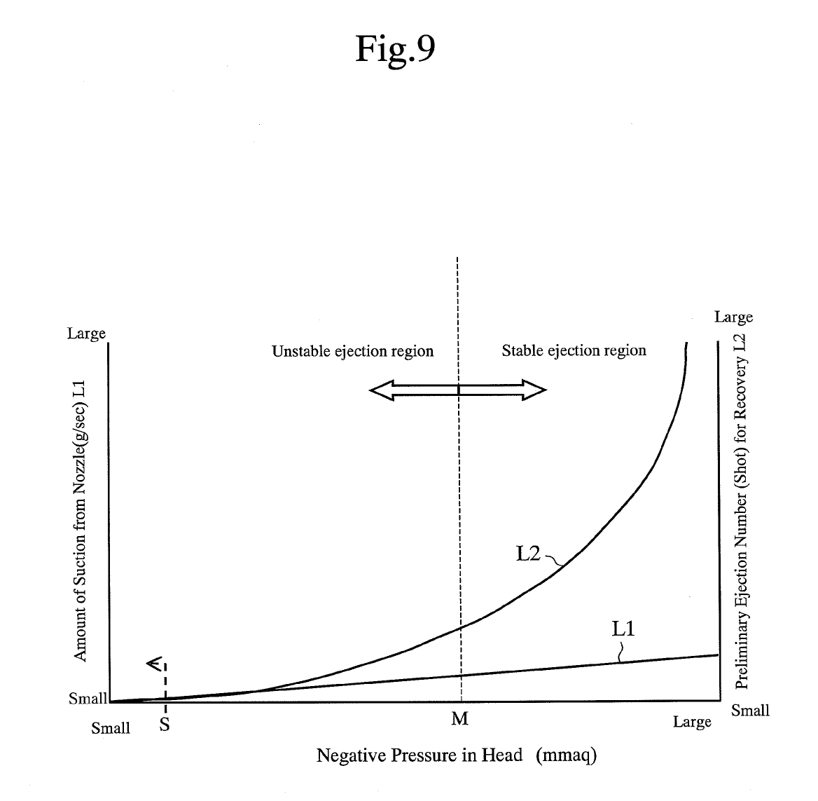

The negative pressure to be applied to the printing head 22K, etc., namely the negative pressure applied to the ink in the nozzle 22Kn, can be changed by changing the rotation frequency of the pressure-adjusting pump 82 (FIG. 3, etc.) as mentioned above. The amount of the ink sucked from the ink ejection outlet 22Ki per unit time, and the amount of the discarded ink for removing the mixed color layer portion depend on the negative pressure applied to the ink in the nozzle 22Kn. This dependency is explained by reference to FIG. 9.

FIG. 9 is a graph showing the dependency of the amount of the ink sucked from the ink outlet per unit time and the amount of the ink discarded for removing the mixed color ink layer portion on the negative pressure applied to the ink in the nozzle. In this graph, the abscissa indicates the negative pressure applied to the ink in the nozzle: The negative pressure increases toward the right side (lower than the atmospheric pressure), and decreases toward the left side (closer to the atmospheric pressure). The ordinate at the right side indicates the number of times of preliminary ejection for discarding the ink to remove the mixed color layer portion: The amount of the discarded ink increases toward the upper side and decreases toward the lower side. The ordinate at the left side indicates the amount of the ink sucked per unit time from the ink ejection outlet: The amount of the sucked ink increases toward the upper side, and decreases toward the lower side.

For ejecting the ink stably from the ink ejection outlet 22Ki of the nozzle 22Kn, the negative pressure should be incessantly applied within a certain pressure range to the ink in the nozzle 22Kn. Specifically, a negative pressure higher than that shown by the symbol “M” in FIG. 9 should be applied to the ink in the nozzle 22Kn to make stable the ejection of the ink during printing. However, under application of a negative pressure higher than “M”, when the blade 150 carrying the attached ink Ic crosses the nozzle 22Kn as shown in FIG. 8D, the ink Ic is liable to be sucked through the ink ejection outlet 22Ki. The liability of the ink suction is higher at the higher negative pressure applied to the ink in the nozzle 22Kn as shown in FIG. 9. Therefore, the ink sucked at the higher negative pressure increases the thickness of the mixed color layer portion Z to necessitate increase of the times of the preliminary ejection, resulting in increase of the amount of the discarded ink. When the negative pressure is excessively high, as shown by the curved line L2 in FIG. 9, the mixed color layer portion Z (FIG. 8D) becomes excessively thick by penetration of the ink sucked through the ink ejection outlet.

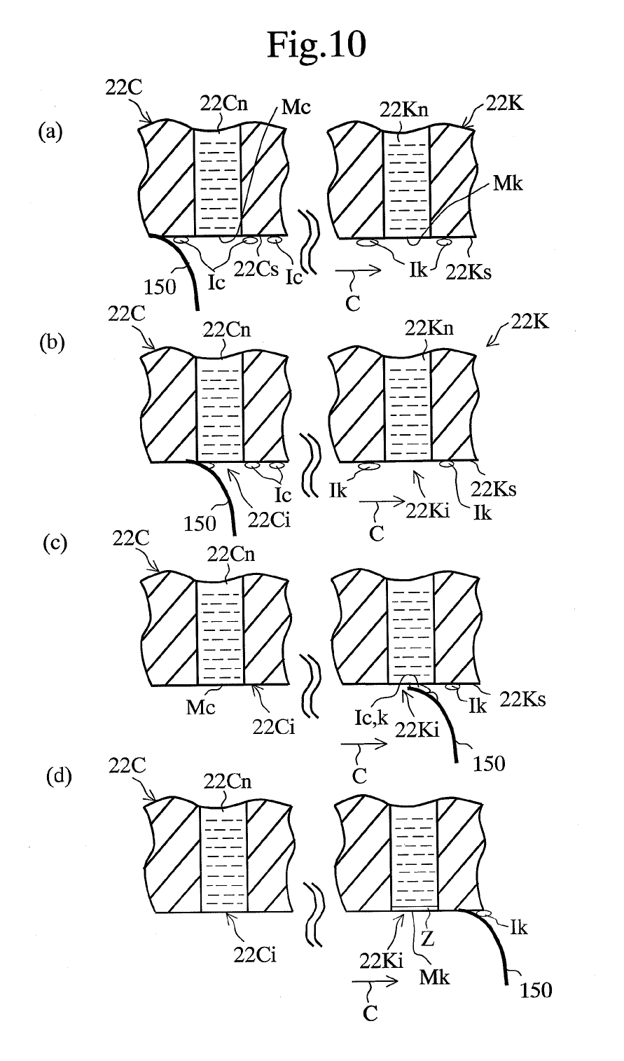

Therefore in the present invention, in removal of the ink Ik depositing on the nozzle face 22Ks with the blade 150, the negative pressure applied to the ink in the nozzle 22Kn is weakened. The weakened negative pressure is in the range lower than the negative pressure S shown in FIG. 9. The pressure applied to the ink in the nozzle 22Kn is adjusted by changing the rotation frequency of the pressure adjusting pump 82 (FIG. 3, etc.) to prevent the penetration of the ink attaching to the blade 150 through the ink ejection outlet 22Ki into the nozzle 22Kn. The meniscuses of the ink at the ejection outlets 22Ci, 22Ki may be made flat as shown by Mc and Mk (FIG. 10) at the same level as the nozzle faces 22Cs, 22Ks by adjusting the rotation frequency of the pressure-adjusting pump 82 (FIG. 3, etc.). Otherwise, the pressure applied to the ink in the nozzle 22Kn may be atmospheric.

An example of prevention of the penetration of the ink attaching to the blade 150 through the ink ejection outlet 22Ki into the nozzle 22Kn is explained below by reference to FIGS. 10A-10D.

FIG. 10A is a sectional view illustrating schematically a state of two nozzle faces just before cleaning with a blade. FIG. 10B is a sectional view illustrating schematically a state of cleaning of a first nozzle face with the blade. FIG. 10C is a sectional view illustrating schematically a state of cleaning of a second nozzle face with the blade after cleaning of the first nozzle face. FIG. 10D is a sectional view illustrating schematically a state at the end of the cleaning of the second nozzle face.

FIGS. 10A-10D show cleaning of the nozzle faces 22Ks, 22Cs by the blade 150 under application of a negative pressure lower than that denoted by the symbol S in FIG. 9 to the inks in the nozzles 22Kn, 22Cn. In this cleaning operation, a pressure equal to the atmospheric pressure (pressure outside the nozzles 22Kn, 22Cn) is applied to the inks in the nozzles 22Kn, 22Cn. Thereby flat meniscuses Mc, Mk are formed at the ejection outlets 22Ci, 22Ki at the same plane level as the nozzle faces 22Cs, 22Ks as shown in FIGS. 10A-10D. The state of successive wiping of inks Ic, Ik on the nozzle faces 22Cs, 22Ks is explained below. In this explanation, one blade 150 is used for wiping the ink Ic from the nozzle face 22Cs and successively wiping the ink Ik from the nozzle face 22Ks.

The blade 150 firstly starts to wipe the ink Ic off from the nozzle face 22Cs of the printing head 22C as shown in FIG. 10A, and then the blade 150 wipes the ink Ic off from the periphery of the ink ejection outlet 22Ci of the nozzle 22Cn as shown in FIG. 10B. Next, the blade 150, with the wiped ink Ic kept attached to the edge portion thereof, wipes the ink Ik off from the nozzle face 22Ks of the printing head 22K. In this wiping step, the blade 150 with the ink Ic attaching thereto crosses the nozzle 22Kn. Since only a slight negative pressure is kept applied to the ink in the nozzle 22Kn, the ink is less liable to be sucked from the blade through the ink ejection outlet 22Ki to form a very thin mixed color ink layer portion Z containing the two color inks Ic and Ik near the ink ejection outlet 22Ki of the nozzle 22Kn as shown in FIG. 10D. When such a thin mixed color ink layer portion Z is formed, the ink in only a small amount corresponding to the mixed color layer portion Z is ejected and discarded from the nozzle 22Kn in the capped state shown in FIG. 10C. The smaller thickness of the mixed color layer portion Z results in a smaller amount of the discarded ink, making the preliminary ejection rarely necessary.

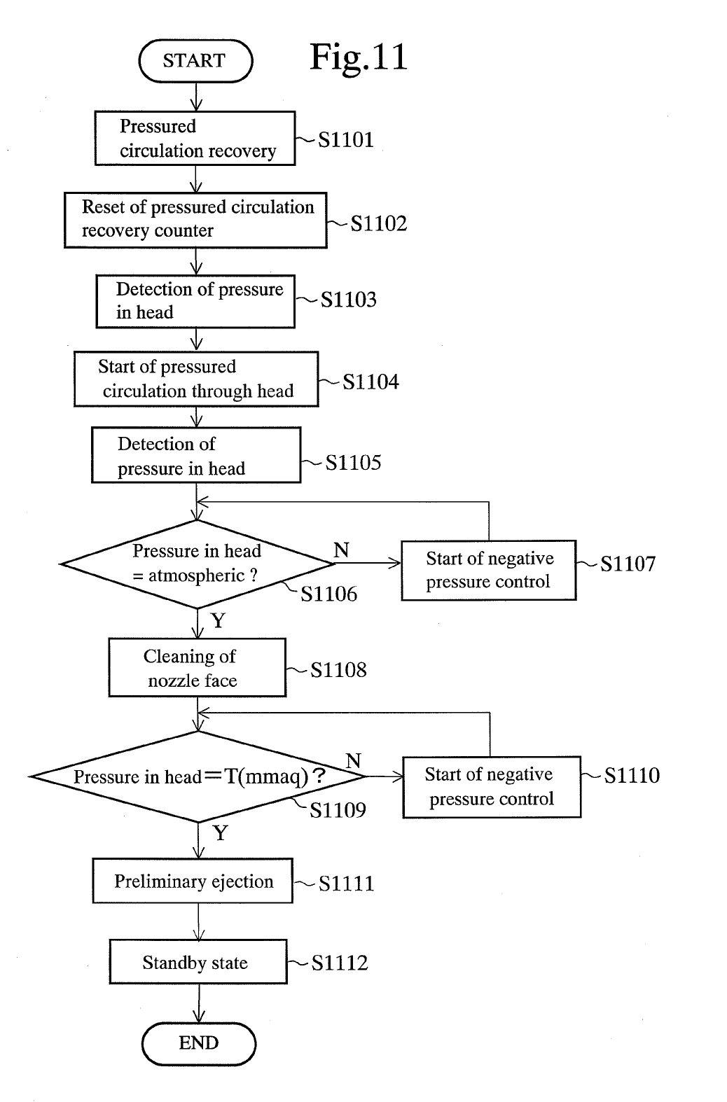

The steps of controlling the pressure in the printing head for the recovery by pressured circulation in the process of FIGS. 7A, 7B, 7C shown above are explained by reference to FIG. 11. Here, the pressure control in the printing head in the pressured circulation recovery is explained. In other recovery operation, the pressure in the printing head is controlled in the same manner.

FIG. 11 is a flow chart of steps of controlling the pressure in the printing head for recovery operation by pressured circulation.

The flow is started by instructions for pressured circulation recovery (S1101). Firstly, a dot counter and recovery timing counter is reset (S1102), Then the pressure in the ink flow channel 66 (the pressure applied to the inside of the printing head 22K, or the pressure applied to the ink in the nozzle 22Kn) is detected by a pressure sensor 81 (FIG. 3)(S1103). Conditions for pressured circulation recovery are decided according to the detected pressure. Then the pressured circulation operation is conducted as shown in FIG. 7A (S1104). Thereafter, again the pressure in the ink flow channel 66 (the pressure applied to the inside of the printing head 22K, or the pressure applied to the ink in the nozzle 22Kn) is detected again by a pressure sensor 81 (FIG. 3)(S1105). The pressure in the ink flow channel 66 is judged whether the pressure is atmospheric or not (S1106). When the pressure is not at the atmospheric pressure, the rotation frequency of the pressure-adjusting pump 82 (FIG. 3, etc.) is changed (S1107) to adjust the pressure in the ink flow channel 66 to be atmospheric.

Subsequently, cleaning of the nozzle face is conducted as described by reference to FIG. 10 (S1108). After the cleaning, the pressure in the ink flow channel 66 is detected by the pressure sensor 81 (FIG. 3)(S119). To bring the pressure within the stable ejection region (FIG. 9), the rotation frequency of the pressure-adjusting pump 82 (FIG. 3, etc.) is changed (S1110). Thereafter, a small amount of preliminary ejection is conducted (S1111) for stabilizing the meniscus formed at the nozzle 22Kn, etc. to bring the nozzle to a standby state (S1112) to end this flow.

As described above, in removal of the ink depositing on the nozzle face by a blade, a pressure is applied to prevent penetration of ink attaching to the blade through the ink ejection outlet into the nozzle. Thereby, trouble caused by mixed color ink is prevented, and the amount of the discarded ink is decreased.

The nozzle face-cleaning method described above is applicable to a system constituted of plural devices (e.g., constituted of a host computer, an interface device, a reader, a printer, etc.), or to a one apparatus (e.g., copying machine, and a facsimile machine). Further, the above nozzle face-cleaning method can be conducted by furnishing a memory medium containing a program code of software for achieving the function shown in the above examples to a system or apparatus, and reading out the program code contained in the memory medium with the computer (CPU or MPU) of the system or apparatus. In this case, the program code itself performs the function of the above example. The recording medium for furnishing the program code includes floppy® disks, hard disks, optical disks, magneto-optical disks, CD-ROMs, CD-Rs, magnetic tapes, nonvolatile memory cards, and ROMs.

The function of the above example can be performed by carrying out the program code read out by the computer. Further, the function of the above example can be performed by conducting a part or the whole of the treatment by an OS (operating system) working under instructions of the program code. Further, the function of the above example can be performed by writing a program code read out from the memory medium into a memory contained in a function-enhancement board in a computer or a function-enhancement unit connected to a computer, and conducting a part or the whole of the treatment by CPU of the function-enhancement board or the function-enhancement unit.

1. A method for cleaning a nozzle face, of an inkjet type image-forming apparatus for forming an image by ejecting an ink onto a recording medium through an ink ejection outlet of a nozzle having a meniscus of the ink, by wiping off the ink attaching to the nozzle face with a wiper blade,
wherein, in wiping of the ink off from the nozzle face, the ink in the nozzle is pressurelized to prevent penetration of the ink from the wiper blade through the ink ejection outlet into the nozzle.

2. A method for cleaning a nozzle face, of an inkjet type image-forming apparatus for forming an image by ejecting an ink onto a recording medium through an ink ejection outlet of a nozzle having a meniscus of the ink, by wiping off the ink attaching to the nozzle face with a wiper blade,
wherein, in wiping the ink off from the nozzle face, a meniscus of the ink is formed flat on the same face as the nozzle face or to be convex to protrude from the nozzle face at the ink ejection outlet.

3. A method for cleaning a nozzle face, of an inkjet type image-forming apparatus for forming an image by ejecting an ink onto a recording medium through an ink ejection outlet of a nozzle having a meniscus of the ink, by wiping off the ink attaching to the nozzle face with a wiper blade,
wherein, in wiping of the ink off from the nozzle face, a pressure higher than the atmospheric pressure is applied to the ink in the nozzle.

4. The method for cleaning the nozzle face according to claim 1, wherein the inkjet type image-forming apparatus has plural printing heads arranged in the direction of the recording medium delivery and ejecting different inks, the plural printing heads respectively have a nozzle face having plural ink ejection outlets arranged in the direction perpendicular to the recording medium delivery direction, and
the nozzle faces of the printing heads are cleaned successively by moving the wiper blade in the direction of the recording medium delivery or in the direction reverse thereto.

5. The method for cleaning the nozzle face according to claim 2, wherein the inkjet type image-forming apparatus has plural printing heads arranged in the direction of the recording medium delivery and ejecting different inks, the plural printing heads respectively have a nozzle face having plural ink ejection outlets arranged in the direction perpendicular to the recording medium delivery direction, and
the nozzle faces of the printing heads are cleaned successively by moving the wiper blade in the direction of the recording medium delivery or in the direction reverse thereto.

6. The method for cleaning the nozzle face according to claim 3, wherein the inkjet type image-forming apparatus has plural printing heads arranged in the direction of the recording medium delivery and ejecting different inks, the plural printing heads respectively have a nozzle face having plural ink ejection outlets arranged in the direction perpendicular to the recording medium delivery direction, and
the nozzle faces of the printing heads are cleaned successively by moving the wiper blade in the direction of the recording medium delivery or in the direction reverse thereto.
